(19) United States
(12) Patent Application Publication
(10) Pub. No.: US 2007/0151528 A1
(43) Pub. Date: Jul. 5, 2007

(54) Method and a system for control of a device for compression

(75) Inventor: Mats Hedman, Sparreholm (SE)

Correspondence Address: YOUNG & THOMPSON, 745 SOUTH 23RD STREET, 2ND FLOOR, ARLINGTON, VA, 22202, US

(73) Assignee: CARGINE ENGINEERING AB, Stockholm (SE)

(21) Appl. No.: 10/586,347

(22) PCT Filed: Jan. 21, 2005
(86) PCT No.: PCT/SE05/00065

§ 371 Date: Jul. 14, 2006

(30) Foreign Application Priority Data
Jan. 22, 2004 (SE) 0400129-3

(51) Int. Cl. F02B 47/02; F02B 1/12; F04B 39/06; F02B 3/00

(52) U.S. Cl. 123/25 D; 123/27 R; 123/294; 417/438

(57) ABSTRACT

A method of compressing a medium in the combustion chamber of a combustion engine, wherein a liquid spray is introduced into the compression chamber during a compression stroke, the liquid is pressurized and heated before introduction into the compression chamber to such a degree that at least a part of the droplets of the spray explode spontaneously upon entrance in the compression chamber. The pressurized liquid has a steam pressure that is above the pressure in the compression chamber, and the liquid has a temperature that exceeds the boiling point of the liquid for the temperature and the pressure that, at the moment of introduction, exists in the compression chamber, and the heat being water. The liquid is heated to such an extent that, at the moment of introduction, it has a temperature that is below the temperature of the medium at the moment of introduction of the liquid.

### TECHNICAL FIELD

The present invention relates to a method of compressing a medium in the combustion chamber of a combustion engine, by which method a liquid, in the state of a spray, is introduced into the compression chamber during a compression stroke and, the liquid is pressurized and heated before it is introduced into the compression chamber to such a degree that at least a part of the droplets of the spray explode spontaneously upon entrance in the compression chamber, the liquid being pressurized to such an extent that, at the moment of introduction, it has a steam pressure that is above the pressure that, at the moment of introduction, exists in the compression chamber, and the liquid being heated to such and extent that, at the moment of introduction, it has a temperature that exceeds the boiling point of the liquid for the temperature and the pressure that, at the moment of introduction, exists in the compression chamber, and the liquid being water.

The invention also relates to a method of compression of a medium in the compression chamber of a compressor, by which method a liquid, in the state of a spray, is introduced into the compression chamber during a compression stroke.

The invention also relates to a system for controlling a device for the compression of a medium in the compression chamber of a combustion engine or a compressor, by which a liquid, in the state of a spray, is introduced into the compression chamber during a compression stroke, and comprising me is for pressurizing and heating said liquid and means for introducing the liquid into the compression chamber, and means for determining the pressure and/or the temperature in the compression chamber.

The invention is particularly suited for being implemented onto compressors and combustion engines and will, therefore, by way of example, be primarily described as implemented on combustion engines.

### THE BACKGROUND OF THE INVENTION

Compressed air is a necessity for combustion engines of different types and is also used to a large extent within the industry. Independent of which type of combustion engines or compressors that is used, and upon the compression of the medium, air or gas, heat is generated, and if said heat could be conducted away as it was generated, the energy required for performing said compression could be decreased. This is a well known fact, and it is called isotherm compression. In combustion engines, the generation of nitrogen oxides could be decreased by having a lower combustion temperature, and the generation of carbon dioxide could be decreased by the aid of an improved efficiency. For the users of compressed air, the operational costs could, thereby, decrease. An isotherm compression, or a compression upon simultaneous cooling could be of value from an environmental point of view.

There have been a large number of attempts to inject water during or before a compression. An attempt to improve the properties of a screw compressor are disclosed in licentiates dissertation named “HEAT EXCHANGE IN LIQUID INJECTED COMPRSSORS”, 1986-01-30, by Jan-Gunnar Persson. There, water droplets were sprayed simultaneously with the introduction of air, and the purpose was to let the water droplets absorb the compression heat from the air in order to decrease the compression work normally required. Preferably, the water droplets would evaporate. Secondly, a plurality of small droplets in the air would, in total, constitute a large cooling surface area. The compression work did decrease to some extent, but the decrease corresponded, in total, to the extra work that was required in order to accomplish the spray. As a hole, the result of the attempt, was that it was not possible to prove any decrease of work. The compression rate was to rapid to enable heat to be transferred from the air to the water droplets, resulting in the non-appearance of any evaporation. This resulted in a need of substantially more water, but, however, the droplets could not be made sufficiently small; in other words, the total cooling surface area, which was the sum of the surfaces of all droplets, was to small. The more and the smaller droplets, the better cooling effect. Accordingly;,favourable factors for an isotherm compression include a large cooling surface area and more time during the compression stroke. These factors are individually exchangeable. For example, a very large cooling surface area may provide for the use of shorter time.

There have also been attempts to inject water into combustion engines for the purpose of decreasing the combustion temperature and, accordingly, the generation of nitrogen oxides, NOx. Other experiments have focused on attaining an improved efficiency by evaporating water against the piston tip and other hot surfaces that surround the combustion chamber. These experiments and tests have proven that the generation of nitrogen oxides decreases with a decreased combustion temperature, and that the efficiency, at least in some cases, has been effected in a favourable direction. However, the results have not been good enough to motivate the use of any commercial systems for transporting and/or recycling water from the exhaust gases of the engines.

US, A1, 20040003781, which is the document regarded as closest prior art, shows how a sub critical or a super critical water spray is injected into a compression chamber during a compression. The temperature as well as the pressure of the injected water are relatively high. Sub critical water is referred to as water with a temperature below the critical temperature of water, which is 373° C., and a super critical temperature is referred to as when the water is above said temperature, which is the temperature at which the liquid phase and the gas phase are not any longer possible to distinguish between.

The basic concept of the present invention is that water injected into a compression chamber, which could be the chamber of a compressor as well as of a combustion engine, is to be used for the purpose of reducing the temperature increase in said chamber, and, accordingly, to contribute to a lower compression work. In the case of combustion engines, the invention is also supposed to contribute to a reduction of the generation of, amongst others, nitrogen oxides.

The method according to the document mentioned above does not reduce the compression work, but could instead be regarded as at least initially increasing the latter by heating the medium that is to be compressed. Water with a pressure of more than 100 bar (10 MPa) and with a temperature of above 523 K (250°+273°) is injected. The result is a flash evaporation by which the evaporation heat is initially taken from the water instead of from the medium to be compressed. The technique described in US, A1, 20040003781 is primarily focused on the reduction of the NOx-exhaust, and not a reduction of the compression work.

### THE OBJECT OF THE INVENTION

The object of the present invention is to solve the problems mentioned above by defining a new method that defines a principal which is applicable for the injection of water during compression into the compression chamber of combustion engines and compressors, for the purpose of decreasing the compression work in such a compressor or combustion engine.

Accordingly, the invention should result in that the water that is used as an injection medium is used in such a way that it increases the efficiency of combustion engines and compressors and reduces the generation of nitrogen oxides in combustion engines.

### SUMMARY OF THE INVENTION

The object of the present invention is achieved, for combustion engines, by means of a method according to the preamble of patent claim 1, said method being characterized in that the liquid is heated to such an extent that, at the moment of introduction thereof, it has a temperature that is below the temperature of the medium at the moment of introduction of the liquid.

The object of the present invention is achieved, for compressors, by the method according to the preamble of patent claim 2, said method being characterized in that the liquid is pressurized and heated, before it is introduced into the compression chamber, to such an extent that at least a part of the droplets of the spray explodes spontaneously upon entrance into the compression chamber. All known methods according to prior art are focused on combustion engine applications. It seems as though prior art is fully focused on what kind of advantages can be obtained through the type of cooling claimed in patent claim 2 in a combustion process, but not in a pure compression process. The invention, as defined in patent claim 2, is therefore more generally defined than the combustion engine implementation which is defined in patent claim 1.

The object of the invention is also achieved by means of the initially defined control system, which is characterized in that it comprises a control unit which is operatively connected with the means for the determination of the pressure and/or the temperature and with the means for pressurisation and heating of the liquid, and that includes a computer program, which is adapted for controlling the means for introducing the liquid into the compression chamber upon basis of the information about the pressure and the temperature in the compression chamber, in accordance with the method according to the invention.

According to preferred embodiments of the method according to patent claim 2, the liquid is, preferably, pressurized to such an extent that, at the moment of introduction thereof, it has a steam pressure that is above the pressure that, at the moment of introduction, exist in the compression chamber. Further, it is preferred that the liquid is heated to such an extent that, at the moment of introduction thereof, it has a temperature that is above the boiling point of the liquid for the temperature and the pressure that, at the moment of introduction thereof, exist in the compression chamber. It is also preferred that the liquid is heated to such an extent that, at the moment of introduction thereof, it has a temperature that is below the temperature of the medium at said moment of introduction.

The invention makes the generation of very small and many droplets possible, resulting in an absorption of the compression heat through a remarkably large cooling surface, and an evaporation, in its turn resulting in a reduced compression work, reduced production casts and a reduced affection of the environment. When the invention is implemented at piston compressors, it must be realized that an extensively large mass of introduced water may cause a so called water stroke. It should be realized that at least a partial evaporation of the exploded spray droplets will occur spontaneously as well as immediately upon the entrance of the liquid into the chamber. A continued evaporation of liquid that has not yet been evaporated takes place during the rest of the compression stroke as the pressure and the temperature in the chamber increase. Preferably, all the liquid that has been introduced into the compression chamber is evaporated during the compression stroke. In this case, liquid is not referred to as fuel (combustion engines), but primarily as water. Preferably, the pressure and the temperature of the spray droplets are such that a substantial part, preferably more than 10%, and more preferably more than 50%, and most preferably all the spray droplets explode upon the entrance into the compression chamber.

An implementation of the present invention will motivate a use of said system commercially for combustion engines. Preferably, the method is possible to use for all types of combustion engines in which the air is compressed. The water that is heated and/or evaporated during the compression and upon the implementation of the invention, absorbs and drains off the compression heat and reduces, accordingly, the compression work, thereby improving the efficiency of the engine. The combustion that follows the compression stroke is initiated with a lower temperature, resulting in a lower maximum temperature and a reduced generation of NOx. However, there is one further temperature-reducing factor, namely that a larger mass, operating medium and water steam, should be heated, instead of only the operating medium, by the energy that is set free during the combustion. Accordingly, the water steam has the same effect as so called EGR, Exhaust Gas Regeneration, which is a common method for the purpose of reducing the generation of NOx through a lower temperature at the combustion. The need of cylinder cooling is reduced, resulting in an improvement of the efficiency. The invention is particularly suitable when hydrogen gas or natural gas is used as fuel, since the recycling of the water is facilitated when the exhaust gases are mainly constituted by water. The method is also suitable upon the compression of, for example, hydrogen gas or natural gas to be used as fuel in combustion engines and in fuel cells.

However, it is preferred that the liquid is heated to such an extent that, at the moment of introduction thereof, it has a temperature that is below the temperature of the medium at the moment of introduction.

In the case of a combustion engine, the liquid is introduced through a valve used by the combustion engine for the purpose of introduction of fuel, and, preferably, simultaneously with the introduction of the fuel.

Preferably, the liquid that is introduced in the compression chamber in accordance with the invention is water, and the medium which is compressed in the compression chamber is air. Thereby, according to the invention, the water should be introduced in the cylinder space when the pressure in the latter is equal to or more than 4.5 bar. The reason therefore is more specifically disclosed in the detailed description of the invention.

Further features and advantages of the present invention will be disclosed in the following description and in the remaining patent claims.

### BRIEF DESCRIPTION OF THE DRAWINGS

Hereinafter, the invention will, by way of example, be described with reference to the annexed drawings, on which:

FIGS. 1a and 1b shows a combustion engine cylinder provided with means for the injection of water and, possibly, fuel together with water, in accordance with the invention, and with a piston in a first and a second position respectively.

FIG. 2 is a schematic representation of a device for the injection of water into a compressor and into a tank connected to the latter.

FIG. 3 shows a device with a principal system solution for a control system according to the invention.

### DETAILED DESCRIPTION OF THE INVENTION

The principal basis of the invention can be seen in table 1. In column A there is shown some different pressures (bar), by adiabatic compression of air, where the air pressure before compression is 1 bar and the temperature is 273 K. Kappa is 1.4. In column B, the temperature (K) is shown for the compressed air with the different pressures according to column A. In column C the boiling point temperature (K) of the water is shown for the different pressures according to column A. The boiling point temperatures of the water for the different pressures are ocularly retrieved from steam pressure curves. Column D shows the pressurisation which is necessary for preventing the water from boiling at the temperature according to column B.

TABLE 1
Different pressures and temperatures during adiabatic
compression of air, and the boiling point temperature of the water at
these pressures. The reference from which the equations for the
calculation of the values at the adiabatic compression, and the
information about the boiling point of the water and the necessary
pressurisation are from the book Energiteknik, Henrik Alvarez,
published by Studentlitteratur i Lund 1990.

| A | B | C | D |
|---|---|---|---|
| (bar) | (° K) | (° K) | (bar) |
| 20 | 642.5 | 485 | 210 |
| 10 | 527.2 | 453 | 40 |
| 6 | 455.6 | 432 | 10 |
| 5 | 432.5 | 423 | 6 |
| 4.5 | 419.8 | 420 | 4.5 |
| 4 | 405.7 | 417 | 3 |
| 3 | 373.8 | 406 | 1 |

Table 1 shows that there is an intersection, marked with bold face, at approximately 4.5 bar. At lower pressures, the boiling point temperature of the water is above the temperature of the compressed air while, simultaneously, the pressurisation necessary in order to prevent the water from boiling is lower than the pressure of the compressed air. At pressures above 4.5 bar, the boiling point temperature of the water is lower than the temperature of the compressed air while, simultaneously, the pressurisation necessary in order to prevent the water from boiling is higher than the pressure of the compressed air. This is the basis for the inventive concept. During injection, spraying, of the water into the medium, which is air or gas, to be compressed, the water should be pressurized and heated to a temperature that will result in a fierce boiling, or explosion, of the water, resulting in a very fine division thereof to water droplets so small that a sufficiently large cooling surface area is obtained, such that heat can be drained off through the heating of the water droplets and/or through an evaporation. As the steam pressure is higher than the compression pressure, an exploding action is achieved on the water as the latter is depressurized at the moment of entrance into the medium under compression. The atomization has been allowed since the water has been supplied with heat before being introduced into the medium to be compressed. It is a feature of the invention that heat, which otherwise would be lost through, for example, exhaust gases and/or a cylinder cooling or in other ways in other contexts, also called waste heat, is used for the heating of the water before the latter is supplied to the medium to be compressed. This can be accomplished through a heat exchange between the combustion exhaust gases and the water, between a cylinder cooling medium and the water, or directly between the cylinder material and the water.

The compression conditions vary between different engines and compressors, as well as the pressure and the temperature of the medium before compression. Upon the implementation of the invention, the conditions should, preferably, be such that there is an intersection similar to the one described above. With pre-compressed and pre-cooled air, which is common by combustion engines, the intersection may be at a compression pressure which is substantially higher than said 4.5 bar. But if the condition is according to table 1, the region above the intersection at 4.5 bar is interesting. Accordingly, the water should be introduced after that the compression pressure has past 4.5 bar. Further, the water should be pressurized and should have a temperature that results in it being depressurized and starting to boil immediately at the introduction. The introduction is preformed by spraying the water into the compression chamber through an inlet valve adapted for the purpose. The already small droplets of the spray will explode during the depressurisation and boiling, and become small water droplets that, on one hand, immediately evaporate and, on the other hand, evaporates during the following compression. A continued generation of compression heat will, accordingly, result in continued heating of non-evaporated water droplets and in a subsequent boiling and evaporation, and the heat used for the evaporation counteracts any further increase of the temperature of the medium. Accordingly, heat is drained off from the air under compression, for the generation of the water steam during the compression. Preferably, the control system according to the invention comprises sensors for sensing the pressure and the temperature in the compression chamber, as well as a control unit, which is operatively connected with these sensors and with the inlet valve, and provided with software constituted by a computer program that controls when the liquid, the water, is to be injected upon basis, of the information that it gets from the pressure and temperature sensors.

By combustion engines, the reduced temperature obtained by the air during the compression will result in the next compression being started at a lower temperature. The whole combustion process will then be affected and will have a lower maximum temperature. The mass to be heated during the combustion has been provided with an addition of water, and, accordingly the mass that is heated is larger than otherwise, resulting in a further lowering of the maximum temperature. Thereby, the invention reduces the generation of nitrogen oxides that are generated at high combustion temperatures. At the same time, the efficiency of the engine is improved, resulting in a reduction of the generation of carbon dioxide by use of fuels based on hydrocarbon. The efficiency of the engine is also effected positively by the reduced heat losses, since the need of cooling of the cylinders of the engine is reduced thanks to the low combustion temperature. The water droplets that occasionally will contact the piston top or other hot surfaces will cool the latter under evaporation, which means that the heat from a previous combustion is returned to the medium, i.e. the air and steam, that is compressed, which is also favourable for the efficiency. The presence of steam improves the heat exchange between the medium and the water droplets that have yet not been evaporated. The draining off of the compression heat can also be used in order to increase the compression and expansion ratios in Otto engines, such that, for example, petrol can be used at compression and expansion conditions similar to the ones of contemporary diesel engines, thereby resulting in an improved efficiency. In diesel engines, the compression and expansion ratio can be increased without any increase of the temperature after the compression stroke, resulting in an improved efficiency as well as a reduced generation of NOx.

Table 2 shows the theoretic saving of power upon a plural step adiabatic compression with intercooling, as compared to isotherm compression. The use of intercooling is the contemporary technique for reducing the compression work. The plural step process is space-demanding. Pressure condition 2-steps 3-steps Isotherm

TABLE 2
Theoretic saving of power by cooled compression. Plural step
adiabatic compression with inter cooling and isotherm compression.
Reference: 1-step adiabatic compression. Kappa is 1.4. The reference
source is a preliminary study named ISOTERM KOMPRESSION, by
Jan-Gunnar Persson, 2000-01-16. The preliminary study has been
done, under secrecy agreement, on the order of the present inventor.
The report has not been published.

| Pressure condition | 2-steps | 3-steps | Isotherm |
|---|---|---|---|
| 20 bar | 21.1% | 26.8% | 36.8% |
| 25 bar | 22.6% | 28.7% | 39.0% |

Table 3 shows the largest possible heat absorption by means of evaporation at the intersection line according to table 1, compared to the need of cooling by isotherm compression from 1 to 25 bars. Further, it can be seen that the possible theoretical saving is 289/389 times the saving of power for an isotherm compression, which, according to table 2, is 39% upon compression up to 25 bar. The saving that, theoretically, is possible by the implementation of the invention is, accordingly, 289/389×39=28.97%; this is comparable to the saving of power at the 3-step compression according to table 2. However, the invention makes it possible to perform the compression in one step, in one and the same cylinder, which is a remarkable advantage.

TABLE 3
is a table that shows the maximum heat absorption per kg
air at the intersection line according to table 1, compared to the need
of cooling per kg air at isotherm compression from 1 to 25 bar. Table
3 also shows the maximum content of steam in air at a given pressure
and temperature, in other words the condensation limit, according
to an intersection line in table 1. Kappa is 1.4. The reference
source is the preliminary study named ISOTERM KOMPRESSION, by
Jan-Gunnar Persson, 2000-01-16.

| | | | | Need of cooling |
|---|---|---|---|---|
| | Steam pressure | Heat of | Max heat | by isotherm |
| Temp | saturation | evaporation | absorption | compression |
| (° K) | (bar) | (kJ/kg) | (kJ/kg) | (kJ/kg) |
| 421 | 4.51 | 2119 | 289 | 389 |

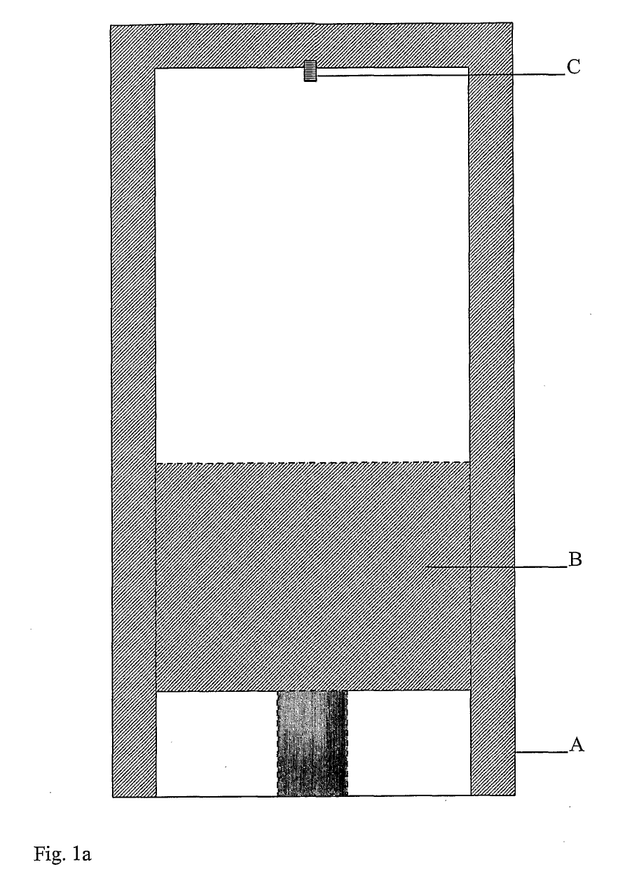

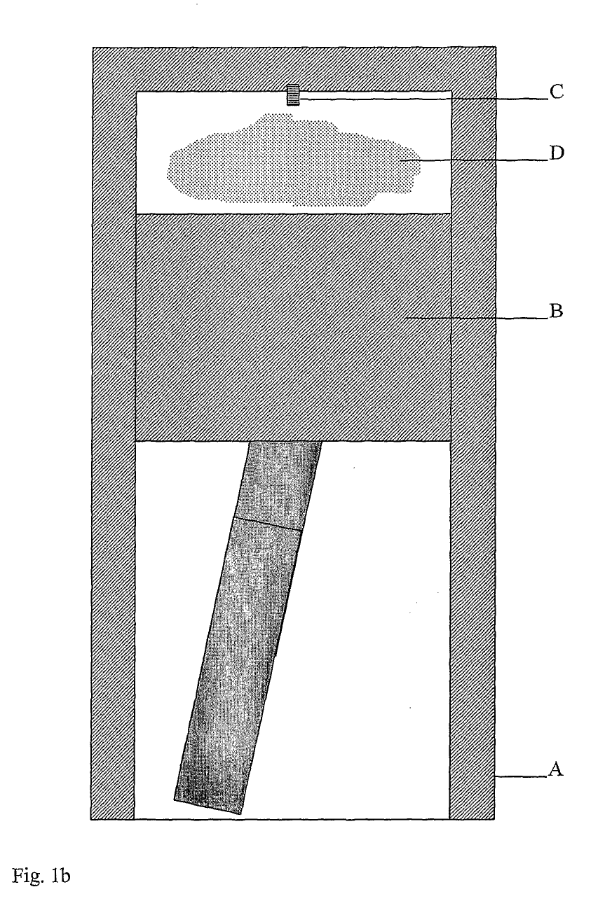

FIGS. 1a and 1b shows an engine cylinder A with a piston B in two positions, a lower position corresponding to the lower dead centre of the piston, and an upper position, approximately 65 crank angle grades before the upper dead centre. The cylinder A is provided with an injection valve C for the injection of pressurized and heated water D. The injection valve may be the same valve as the one that is occasionally used for the injection of fuel. The water and the fuel may be mixed and simultaneously injected, resulting in the fuel being pressurized and heated to the same level as the water. The engine is a 2-stroke or 4-stroke combustion engine with a compression ratio of 20:1. The figure does not show self evident components such as inlet and outlet ports or inlet or outlet valves, any possible, separate fuel injection valve, or any possible sparking plug. Before the compression stroke, with the piston B in its lower dead centre position, the cylinder A is supposed to be filled with air of approximately 1 atmosphere at a temperature of 300 K. Kappa is supposed to be 1.4. When the piston B is in its position 65 crank angle grades before its upper dead centre position, the compression pressure is approximately 4.7 bar and the temperature is approximately 465 K. If the invention is not implemented, the pressure and the temperature at the upper dead centre of the piston will be approximately 66 bar and 995 K respectively, and approximately 75% of the, compression work would remain. From a position of approximately 65 crank angle grades before the upper dead centre and farther on to the dead centre, the invention can, according to this example, be implemented. For example, a control system may be adapted to inject water with, in accordance with table 1, a temperature of 453 K and pressure of 40 bar when the compression pressure is 6 bar and the temperature is approximately 456 K, however without claiming that this setting is optimal. The large depressurisation, 40 bar in comparison to 6 bar, and the heat energy of the water at the moment of introduction of the water into the cylinder, results in a fierce boiling and, accordingly, a fine atomization, and generation of a water curtain, with a very large cooling surface area. A certain amount of the introduced water is immediately evaporated in a few microseconds, resulting in a temperature reduction. A further evaporation takes place during the continued compression process.

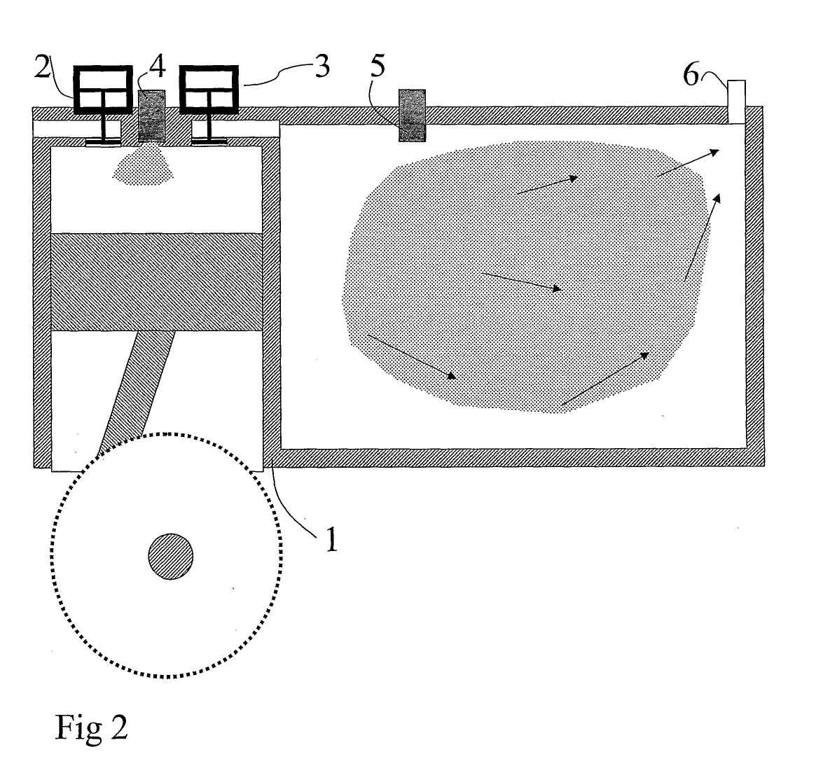

FIG. 2 shows a compressor with a tank 1 and an air inlet valve 2 and an outlet valve 3 through which compressed air is conducted to the tank. From the tank pressurized and suitably cooled air is conducted to a combustion engine through a connection 6. There are two inlet valves for heated water; on one hand the valve 4 in the compressor and on the other hand a valve 5 in the tank. A compression takes place in the compressor, and water is sprayed, with regard taken to the prevention of any water stroke. Evaporation, in other words a cooling of air, takes place in the tank. Here, there is shown a tank connected to a compressor. The tank may also constitute a source for the feeding of pressurized air to the combustion chamber in a combustion engine.

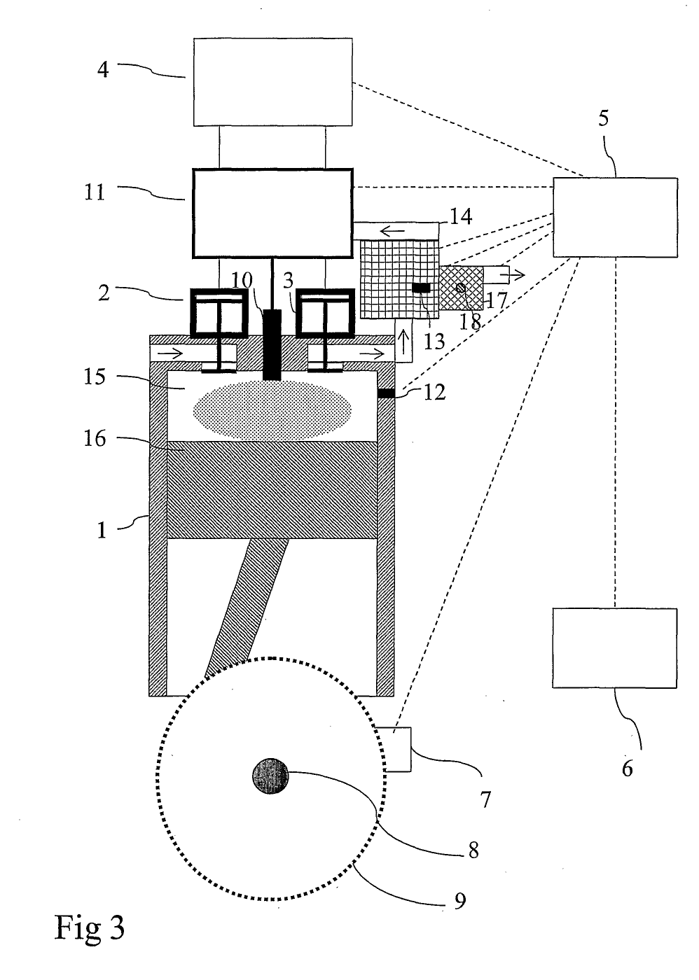

FIG. 3 is a schematic representation showing, by way of example, a cylinder 1 with a piston 16. The inlet valve 2 and the outlet valve 3 are valves, for example valves that are operable independent of the crank shaft position and without any cam shaft operation, that are both closed during a compression stroke. The piston 16 has reached a position in which water, possibly together with fuel, is injected into the compression chamber/combustion chamber 15 through the injection valve 10. The water is supposed to cool the air which is compressed in the chamber 15, and possibly also the surfaces that surround the chamber 15, and a boiling/evaporation takes place prior to a combustion stroke. A circuit 4, for example a pressure fluid circuit such as a pressurized air circuit, is used for the activation and operation of the valves 2 and 3. A control unit 5 is operatively connected with the circuit 4 for signal control of the circuit and the valves 2 and 3 connected with the circuit. A member 6, for example a gas pedal of a vehicle driven by the engine, is operatively connected with the control unit 5 in order to order the required torque. A gauge 7, at a graduated ark 9 mounted on the crank shaft, is operatively connected with the control unit 5 and supplies the control unit 5 with continuous information of the number of revolutions of the engine and of the position of the piston 16 in the cylinder 1. The control unit 5 decides when the operable valves 2 and 3 are to open or to close. A circuit 11, for example a pressurized fluid circuit, such as a pressurized air circuit, is operatively connected with the control unit 5 and is used for the purpose of activating the injection valve 10 for the introduction of water. A return member 14 is used for the purpose of returning water, for injection through the injection valve 10. In a heat exchanger, which is connected to the exhaust gas system and which is provided with a sensor 13 for sensing the pressure and/or temperature of the water and operatively connected to the control unit 5, a heating and pressurisation of the water takes place. Through the return member 14, on basis of a control signal from the control unit 5 to the circuit 11, for the activation of the injection valve 10, water is supplied to the chamber 15. A sensor 12, operatively connected to the control unit 5, provides information to the control unit 5 about the temperature and/or pressure of the air that is compressed in the chamber 15. The control unit 5 uses the information from the sensor 12 in order to decide when the circuit 11 shall be ordered to activate the injection valve 10 for the injection of water into the chamber 15. The water steam that is generated by the compression is mixed with exhaust gases at the subsequent combustion and expansion strokes and is transported to an exhaust gas system connected to the engine. In a heat exchanger 17, which is operatively connected to the control unit 5, downstream the heat exchanger 7 in the exhaust gas system, the required amount of water is recycled by means of condensation, air-cooling of the exhaust gases. This water, the condensate, is purified in a particle filter 18, which, in this case, is located in the heat exchanger 17, before being reused. From the heat exchanger 17, the water is transported to the heat exchanger that is provided with the sensor 13. The injection valve 10 may be divided into two separate valves, one for water and one for fuel. In an Otto engine, it might also be semi-detached together with a sparking plug. It might be semi-detached with the fuel injection valve in a diesel engine. It should be emphasized that the invention, advantageously, also can be implemented on engines with a conventional cam shaft.

Further, it should be realized that the invention only has been described by way of example, and that a plurality of alternative embodiments should be obvious for a person skilled in the art, without departing from the scope of protection that is defined in the annexed patent claims, as interpreted with support of the description and the annexed drawings.

For example, the sensors for measuring the pressure and temperature may, in certain cases, be avoided and/or substituted by means for gathering information about the crank shaft position and/or possible other parameters, that are depending on or that determine the temperature/pressure in the combustion chamber. One example of such a further parameter is the added amount of air before the compression (relevant both for 2-stroke and 4-stroke operation).

1. A method of compressing a medium in the combustion chamber (15) of a combustion engine, by which method a liquid, in the state of a spray, is introduced into the compression chamber (15) during a compression stroke, and the liquid is pressurized and heated before it is introduced into the compression chamber (15) to such a degree that at least a part of the droplets of the spray explode spontaneously upon entrance in the compression chamber (15), the liquid being pressurized to such an extent that, at the moment of introduction, it has a steam pressure that is above the pressure that, at the moment of introduction, exists in the compression chamber (15), and the liquid being heated to such an extent that, at the moment of introduction, it has a temperature that exceeds the boiling point of the liquid for the temperature and the pressure that, at the moment of introduction, exists in the compression chamber (15), and the liquid being water, characterized in that the liquid is heated to such an extent that, at the moment of introduction, it has a temperature that is below the temperature of the medium at the moment of introduction of the liquid.

2. A method of compression of a medium in a compression chamber of a compressor, by which method a liquid, in a state of a spray, is introduced into the compression chamber during a compression stroke, characterized in that the liquid is pressurized and heated before being introduced into the compression chamber, to such an extent that at least a part of the droplets of the spray explodes spontaneously upon entrance into the compression chamber.

3. A method according to claim 2, characterized in that the liquid is pressurized to such an extent, at the moment of introduction, it has a steam pressure that is above the pressure that, at the moment of introduction, exists in the compression chamber.

4. A method according to claim 2, characterized in that the liquid is heated to such an extent that, at the moment of introduction, it has a temperature that is above the boiling point of the liquid for the temperature and the pressure that, at the moment of introduction, exists in the compression chamber.

5. A method according to claim 2, characterized in that the liquid is heated to such an extent that, at the moment of introduction, it has a temperature that is below the temperature of the medium at the moment of introduction.

6. A method according to claim 1, characterized in that, in a combustion engine, the liquid is introduced through a valve (10) that is used by the combustion engine for the purpose of introduction of fuel.

7. A method according to claim 6, characterized in that the liquid and the fuel are introduced simultaneously.

8. A method according to claim 1, characterized in that a mixture of the previously compressed medium and the vaporized liquid is evacuated after the compression, and in that the liquid, after said evacuation, is separated by means of condensation.

9. A method according to claim 8, characterized in that the liquid is refined from solid contamination and is retransported to a suitable storing chamber.

10. A method according to claim 1, characterized in that the liquid that is introduced is water and that the medium that is compressed in the compression chamber is air.

11. A method according to claim [[1 and]] 10, characterized in that the water is introduced into the cylinder space when the pressure in the latter is equal to or more than 4.5 bar.

12. A system for controlling a device for the compression of a medium in the compression chamber (15) of a combustion engine or a compressor, by which a liquid, in the state of a spray, is introduced into the compression chamber (15) during a compression stroke, comprising means for pressurizing and heating said liquid and means (10) for introducing the liquid into the compression chamber (15), and means (12) for determining the pressure and/or the temperature in the compression chamber (15), characterized in that it comprises a control unit (5) that is operatively connected with the means (12) for determining the pressure and/or the temperature and with the means for pressurizing and heating the liquid, and including a computer program which is adapted for the purpose of controlling the means (10) for the introduction of the liquid into the compression chamber (15) upon basis of the information concerning the pressure and the temperature in the compression chamber and in accordance with the method according to anyone of claims 1-11 claim 1.

13. A method according to claim 3, characterized in that the liquid is heated to such an extent that, at the moment of introduction, it has a temperature that is below the temperature of the medium at the moment of introduction.

14. A method according to claim 4, characterized in that the liquid is heated to such an extent that, at the moment of introduction, it has a temperature that is below the temperature of the medium at the moment of introduction.
